(19) United States
(12) Patent Application Publication
(10) Pub. No.: US 2009/0229087 A1
(43) Pub. Date: Sep. 17, 2009

(54) Releasable Fastener Assembly

(76) Inventor: Stanley Schneider, Gates Mills, OH (US)

Correspondence Address: ULMER & BERNE LLP;ATTN: DIANE BELL, 600 VINE STREET, SUITE 2800, CINCINNATI, OH, 45202, US

(21) Appl. No.: 12/396,449

(22) Filed: Mar. 2, 2009

Related U.S. Application Data
(60) Provisional application No. 61/067,538, filed on Feb. 28, 2008.

(51) Int. Cl. A44B 11/25; A44B 11/20; B23P 11/00

(52) U.S. Cl. 24/197; 24/163 R; 29/428

(57) ABSTRACT

A releasable fastener assembly comprises a flexible strap having a plurality of apertures extending through the thickness of the strap and a plurality of grommets positioned in each one of the plurality of apertures. Each of the plurality of grommets comprises a first annular end flange having a substantially flat portion, a second annular end flange, and a generally cylindrical portion that defines a passage. The assembly also comprises a pin having a shaft, a head, and a retractable latching mechanism. The flexible strap is configured to define a loop such that the passages of a first one and a second one of the plurality of grommets are aligned. The pin is selectively insertable through the passages such that the retractable latching mechanism abuts the substantially flat portion of one of the annular flanges when the pin is inserted through the passages of the first and second grommets.

### PRIORITY CLAIM

This application claims priority to and the full benefit of U.S. Provisional Patent Application Ser. No. 61/067,538 filed Feb. 28, 2008, and titled “RELEASABLE FASTENER ASSEMBLY,” which is incorporated by reference as if fully rewritten herein.

### TECHNICAL FIELD

This disclosure relates generally to the field of releasable fastener assemblies for fastening leather or other flexible material together, and more specifically, to the field of releasable fastener assemblies in the area of equestrian products.

### SUMMARY

A releasable fastener assembly comprises a flexible strap having a thickness, the flexible strap defining a plurality of apertures, each of the apertures extending through the thickness of the strap and a plurality of grommets, each of the plurality of grommets being positioned in one of the plurality of apertures of the flexible strap and engaged with the flexible strap. Each of the plurality of grommets comprises first annular end flange, the first annular end flange comprising an outer surface, the outer surface comprising a substantially flat portion, a second annular end flange opposite the first annular end flange, and a generally cylindrical portion, the generally cylindrical portion extending between the first annular end flange and the second annular end flange and defining a passage extending through the grommet. The releasable fastener assembly further comprises a pin comprising a shaft, the shaft comprising a proximal end and a distal end, a head integral with the distal end of the shaft, and a retractable latching mechanism positioned proximate to the proximal end of the shaft. The flexible strap is configured to define a loop such that the passage of a first one of the plurality of grommets is aligned with the passage of a second one of the plurality of grommets, the pin is selectively insertable through the passage of the first one of the plurality of grommets and through the passage of the second one of the plurality of grommets, and the head of the pin abuts the second annular flange of the first one of the plurality of grommets and the retractable latching mechanism abuts the substantially flat portion of the outer surface of the first annular flange of the second one of the plurality of grommets when the pin is inserted through the passage of each of the first and the second ones of the plurality of grommets.

A releasable fastener assembly comprises a flexible strap having a thickness, the flexible strap defining a plurality of apertures, each of the apertures extending through the thickness of the strap and a plurality of grommets, each of the plurality of grommets being positioned in one of the plurality of apertures of the flexible strap and engaged with the flexible strap. Each of the plurality of grommets comprises a first annular end flange, a second annular end flange opposite the first annular end flange, a first generally cylindrical portion with a first inner diameter and a second generally cylindrical portion with a second inner diameter, the second inner diameter being greater than the first inner diameter. The first and second inner diameters cooperate to define a passage extending through the grommet. The first generally cylindrical portion comprises a substantially flat annular surface within the passage. A pin comprises a shaft, the shaft comprising a proximal end and a distal end, a head integral with the distal end of the shaft, and a retractable latching mechanism positioned proximate to the proximal end of the shaft. The flexible strap is configured to define a loop such that the passage of a first one of the plurality of grommets is aligned with the passage of a second one of the plurality of grommets, the pin is selectively insertable through the passage of the first one of the plurality of grommets and through the passage of the second one of the plurality of grommets, and the head of the pin abuts the second annular flange of the first one of the plurality of grommets and the retractable latching mechanism abuts the substantially flat annular surface when the pin is inserted through the passage of each of the first and the second ones of the plurality of grommets.

The releasable fastener assembly can be configured so that the proximal end of the shaft is located between the first and second annular end flanges of the second one of the plurality of grommets when the pin is inserted through the passage of each of the first and the second ones of the plurality of grommets.

A releasable fastener assembly comprises a flexible strap having a thickness, the flexible strap defining a plurality of apertures, each of the apertures extending through the thickness of the strap and a plurality of grommets, each of the plurality of grommets being positioned in one of the plurality of apertures of the flexible strap and engaged with the flexible strap. Each of the plurality of grommets comprises a first annular end flange, a generally cylindrical portion having a first inner diameter, and a second annular end flange opposite the first annular end flange, the second annular end flange having a second inner diameter. The first inner diameter is greater than the second inner diameter and the first and second inner diameters cooperate to define a passage extending through the grommet. The second annular end flange comprises a substantially flat annular surface within the passage. The releasable fastener assembly further comprises a pin comprising a shaft, the shaft comprising a proximal end and a distal end, a head integral with the distal end of the shaft, and a retractable latching mechanism positioned proximate to the proximal end of the shaft. The flexible strap is configured to define a loop such that the passage of a first one of the plurality of grommets is aligned with the passage of a second one of the plurality of grommets, the pin is selectively insertable through the passage of the first one of the plurality of grommets and through the passage of the second one of the plurality of grommets, and the head of the pin abuts the second annular flange of the first one of the plurality of grommets. The retractable latching mechanism abuts the substantially flat annular surface within the passage of the second one of the plurality of grommets when the pin is inserted through the passage of each of the first and the second ones of the plurality of grommets.

The releasable fastener assembly can also be configured so that the proximal end of the shaft is located between the first and second annular end flanges of the second one of the plurality of grommets when the pin is inserted through the passage of each of the first and the second ones of the plurality of grommets.

A releasable fastener assembly comprises a first flexible strap having a first thickness, the first flexible strap defining a first aperture, the first aperture extending through the first thickness of the strap; a second flexible strap having a second thickness, the second flexible strap defining a second aperture, the second aperture extending through the second thickness of the strap; a first grommet positioned in the first aperture and engaged with the first flexible strap, and a second grommet positioned in the first aperture and engaged with the second flexible strap. Each of the first and second grommets comprise a first annular end flange, the first annular end flange comprising an outer surface, the outer surface comprising a substantially flat portion, a second annular end flange opposite the first annular end flange, and a generally cylindrical portion. The generally cylindrical portion extends between the first annular end flange and the second annular end flange and define a passage extending through the grommet. The releasable fastener assembly further comprises a pin comprising a shaft, the shaft comprising a proximal end and a distal end, a head integral with the distal end of the shaft, and a retractable latching mechanism positioned proximate to the proximal end of the shaft. The first flexible strap and the second flexible strap are positioned such that the passage of the first grommet is aligned with the passage of the second grommet, the pin is selectively insertable through the passage of the first grommet and through the passage of the second grommet, and the head of the pin abuts the second annular flange of the first grommet. The retractable latching mechanism abuts the substantially flat portion of the second grommet when the pin is inserted through the passage of each of the first and the second grommets.

A releasable fastener assembly comprises a first flexible strap having a first thickness, the first flexible strap defining a first aperture, the first aperture extending through the first thickness of the strap and a second flexible strap having a second thickness, the second flexible strap defining a second aperture, the second aperture extending through the second thickness of the strap. A first grommet is positioned in the first aperture and engaged with the first flexible strap. A second grommet is positioned in the second aperture and engaged with the second flexible strap. Each of the first and second grommets comprises a first annular end flange, a second annular end flange opposite the first annular end flange, a first generally cylindrical portion with a first inner diameter and a second generally cylindrical portion with a second inner diameter, the second inner diameter greater than the first inner diameter. The first and second inner diameters cooperate to define a passage extending through the grommet. The first generally cylindrical portion comprises a substantially flat annular surface within the passage. The releasable fastener assembly further comprises a pin comprising a shaft, the shaft comprising a proximal end and a distal end, a head integral with the distal end of the shaft, and a retractable latching mechanism positioned proximate to the proximal end of the shaft. The first flexible strap and the second flexible strap are configured such that the passage of the first grommet is aligned with the passage of the second grommet, the pin is selectively insertable through the passage of the first grommet and through the passage of the second grommet, and the head of the pin abuts the second annular flange of the first grommet and the retractable latching mechanism abuts the substantially flat annular surface when the pin is inserted through the passage of each of the first and the second grommets.

The releasable fastener assembly can also be configured so that the proximal end of the shaft is located between the first and second annular end flanges of the second grommet when the pin is inserted through the passage of each of the first and the second grommets.

A releasable fastener assembly comprises a flexible strap comprising a first portion with a first thickness, the flexible strap defining a first aperture, the aperture extending through the first thickness of the first portion and a second portion comprising a first layer and a second layer of flexible material. The first layer has a first layer thickness and defines a second aperture extending through the first layer thickness. A grommet is positioned in the first aperture and engaged with the first portion of the flexible strap. The grommet comprises a first annular end flange, the first annular end flange comprising an outer surface, the outer surface comprising a substantially flat portion, a second annular end flange opposite the first annular end flange, and a generally cylindrical portion. The generally cylindrical portion extends between the first annular end flange and the second annular end flange and defines a passage extending through the grommet. The releasable fastener assembly further comprises a pin comprising a shaft, the shaft comprising a proximal end and a distal end and sized to be press fit with the second aperture, a head integral with the distal end of the shaft and sized to be larger than the second aperture, and a retractable latching mechanism positioned proximate to the proximal end of the shaft. The proximal end of the pin extends through the second aperture, the first and second layers are affixed to each other and the pin head is captured between the first and second layers. The first and second portions of the flexible strap are configured to define a loop such that the passage of the grommet is aligned with the pin, the pin is selectively insertable through the passage of the first grommet, and the retractable latching mechanism abuts the substantially flat portion when the pin is inserted through the passage of the first grommet.

The releasable fastener assembly can be configured such that the first and second layers are affixed by sewing. The releasable fastener assembly can also be configured so that the first and second layers are affixed by gluing.

A releasable fastener assembly comprises a first flexible strap having a first thickness, the first flexible strap defining a first aperture, the first aperture extending through the first thickness and a second flexible strap. The second flexible strap comprises a first layer and a second layer of flexible material, the first layer having a first layer thickness and defining a second aperture. The second aperture extends through the first layer thickness. A grommet is positioned in the first aperture and engaged with the first flexible strap. The grommet comprises a first annular end flange, the first annular end flange comprising an outer surface, the outer surface comprising a substantially flat portion, a second annular end flange opposite the first annular end flange, and a generally cylindrical portion. The generally cylindrical portion extends between the first annular end flange and the second annular end flange and defines a passage extending through the grommet. The releasable fastener assembly further comprises a pin comprising a shaft, the shaft comprising a proximal end and a distal end and sized to be press fit with the second aperture, a head integral with the distal end of the shaft and sized to be larger than the second aperture, and a retractable latching mechanism positioned proximate to the proximal end of the shaft. The proximal end of the pin extends through the second aperture, the first and second layers are affixed to each other and the pin head is captured between the first and second layers. The first flexible strap and the second flexible strap are positioned such that the passage of the grommet is aligned with the pin. The pin is selectively insertable through the passage of the grommet and the retractable latching mechanism abuts the substantially flat portion when the pin is inserted through the passage of the grommet.

This releasable fastener assembly can be configured so that the first and second layers are affixed by sewing. The releasable fastener assembly can also be configured so that the first and second layers are affixed by gluing.

A method for attaching a grommet to a flexible strap comprises the steps of creating a plurality of apertures in the flexible strap and positioning each one of a plurality of grommets into the respective one of the plurality of apertures. Each of the plurality of grommets comprises a first annular end flange, the first annular end flange comprising an outer surface, the outer surface comprising a substantially flat portion, a second annular end flange opposite the first annular end flange, and a generally cylindrical portion. The generally cylindrical portion extends between the first annular end flange and the second annular end flange and defines a passage extending through the grommet and engages each of the plurality of grommets with the strap. The engaging of each of the plurality of grommets with the strap creates the substantially flat portion.

### BACKGROUND

There are many reasons to join portions of leather and fabric straps to each other. In some cases portions of a single strap can be joined together to create a loop that can secure or retain an item. In other cases, separate straps are desired to be fastened together for a variety of purposes. Often, an important consideration when joining such straps is the degree of permanence desired. Often a permanent join is desired, while in other instances, a non-permanent join is desired. Non-permanent joins can have further considerations such as sturdiness, ease of disconnection and reconnection and usage environment concerns.

More permanent fastening techniques include riveting, sewing, and gluing. Techniques for non-permanent securement of fastened articles include snaps, bolts and nuts (for example, Chicago screws), hooks and clasps, and threaded ties.

Conventional uses of grommets in fastening devices include support of a substrate material such as a flexible strap or protection of an item that passes through the grommet. The material being joined can often play a part in the consideration of fastening techniques. Materials used in the equestrian arts tend be thick and durable. The equestrian field has particular requirements. For example, fastening is performed to assemble various pieces of tack together in a permanent fashion, as well as to fasten items to each other in a sturdy, but non-permanent manner. Devices in the equestrian arts are often used in stables, paddocks, corrals, show arenas, fields and the like.

### BRIEF DESCRIPTION OF THE DRAWINGS

FIG. 1A is a cross-sectional view of a releasable fastener assembly according to one embodiment.

FIG. 1B shows an enlarged view of a portion of FIG. 1A

FIG. 1C is a perspective view of one of the grommets shown in FIGS. 1A and 1B.

FIG. 2A is a cross-sectional view of a releasable fastener assembly according to a second embodiment.

FIG. 2B is an enlarged view of a portion of FIG. 2A.

FIG. 3 is a cross-sectional, perspective view of a grommet according to another embodiment.

FIG. 4A is an exploded view, in perspective, of a grommet according to yet another embodiment.

FIG. 4B is a cross-sectional view of a releasable fastener assembly according to still another embodiment.

FIG. 4C shows an enlarged view of a portion of FIG. 4B.

FIG. 5A is a cross-sectional view of a releasable fastener assembly according to a further embodiment.

FIG. 5B shows an enlarged view of a portion of FIG. 5A.

FIG. 6A is a cross-sectional view of a releasable fastener assembly according to a still further embodiment.

FIG. 6B shows an enlarged view of a portion of FIG. 6A.

FIG. 7 is a cross-sectional view of a releasable fastener assembly according to an additional embodiment.

FIG. 8 is a cross-sectional view of a releasable fastener assembly according to yet another additional embodiment.

FIG. 9A is a section view of one embodiment

FIG. 9B is a plan view of the embodiment shown in FIG. 9A.

FIG. 10 is a plan view of a portion of releasable fastener assembly.

FIG. 11A is a perspective view of a device according to an embodiment.

FIG. 11B is an enlarged view of a portion of FIG. 11A.

FIG. 11C is a plan view of the device depicted in FIG. 11A.

FIG. 11D is a cross-sectional view of the device shown in FIG. 11A in use.

FIG. 11E is a cross-sectional a view of the device shown in FIG. 11A in use.

FIG. 12 is a perspective view of a prior art releasable fastener.

FIG. 13 is a side elevation view of the prior art FIG. 12 in an assembly.

FIG. 14 is a perspective view of the assembly depicted in FIG. 13.

FIG. 15 is a side elevation view of a prior art releasable fastener assembly.

FIG. 16 is a perspective view of the assembly illustrated in FIG. 15.

### DETAILED DESCRIPTION

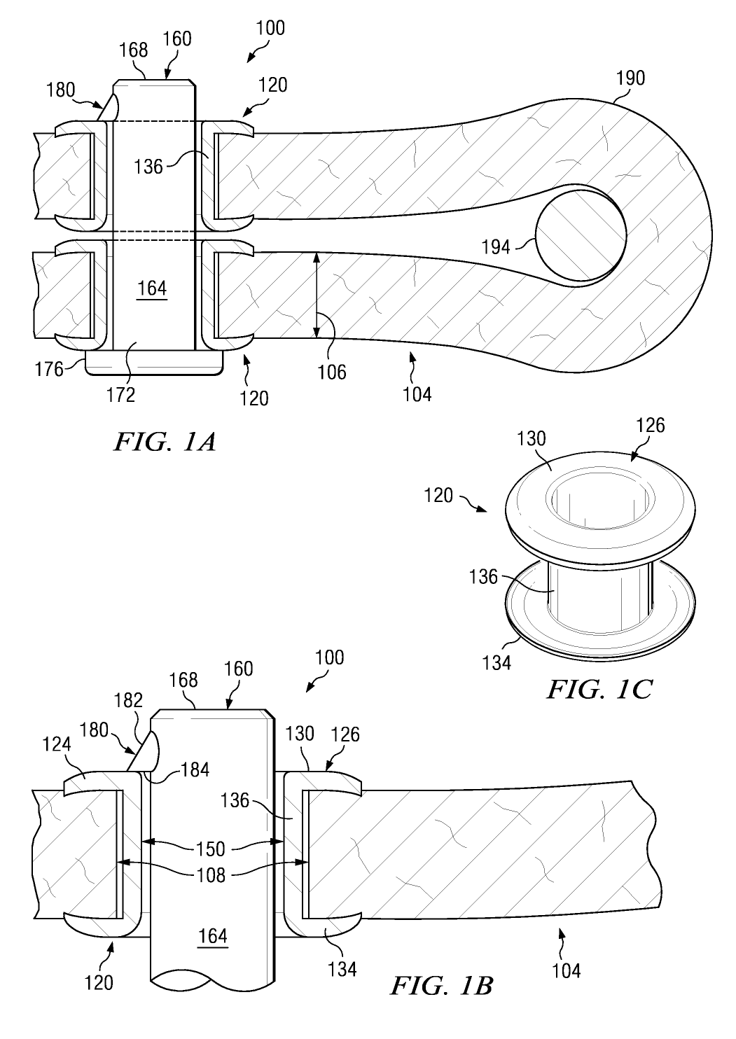

Referring to the drawings, wherein like numbers indicate the same or corresponding elements. FIGS. 1A, 1B and 1C illustrate a releasable fastener assembly 100 according to one embodiment. Releasable fastener assembly 100 can include a single flexible strap 104 that can be configured to form a loop 190. Loop 190 can be used to connect equestrian devices together, for example, a bit 194 can be connected to flexible strap 104 such that the movement of flexible strap 104 can then direct the connected bit 194. Flexible strap 104 can be made of leather or other flexible material such as natural or synthetic fabrics or another suitable material.

In the releasable fastener assembly 100, the flexible strap 104 defines a plurality of apertures 108. The apertures 108 can be formed by methods common in the art such as punching. The flexible strap 104 has a thickness 106. Each of the plurality of apertures 108 can extend through the thickness 106. Releasable fastener assembly 100 can include a plurality of grommets 120. Each of the grommets 120 can be positioned within a respective one of the apertures 108.

The grommet 120 can have a first annular end flange 124, a second annular end flange 134 opposite the first annular end flange 124 and a generally cylindrical portion 136 extending between the first 124 and second annular end flanges 134. The generally cylindrical portion 136 defines a passage 150 through the grommet 120. Each of the first annular end flange 124 and the second annular end flange 134 can engage the flexible strap 104. The first annular end flange 124 has an outer surface 126 that can include a substantially flat portion 130 which provides a contact surface as will be further discussed herein.

The releasable fastener assembly 100 can also include a pin 160. The pin 160 has a shaft 164 that can be selectively insertable through the passage 150 of the grommet 120, as will be further discussed herein. The shaft 164 can have a proximal end 168 and a distal end 172. The pin 160 can have a head 176 integral with the distal end 172 of shaft 164. The head 176 can be larger than the shaft 164. The pin 160 can also include a retractable latching mechanism 180, positioned proximate to the proximal end 168 of the shaft 164. The retractable latching mechanism 180 can be spring-biased such that the retractable latching mechanism 180 protrudes in a rest state, but is capable of being moved such that the retractable latching mechanism 180 can be largely or substantially contained within the shaft 164. Selectively inserting the pin 160 into the passage 150 can apply pressure to an angled leading surface 182 of retractable latching mechanism 180 and can move the retractable latching mechanism 180 to a position (not shown) largely within the shaft 164 of the pin 160, thus allowing the pin 160 to clear the passage 150. A trailing surface 184 of retractable latching mechanism 180 can serve as a restraining surface so that the pin 160 remains in place.

In this embodiment, the pin 160 can be selectively inserted into the passage 150 of the first grommet 120. After the retractable latching mechanism 180 clears the generally cylindrical portion 136, the generally cylindrical portion 136 no longer restrains the retractable latching mechanism 180 and the retractable latching mechanism 180 returns to its protruded rest state. In this state, while the releasable fastener assembly 100 is not in a completely fastened state, the trailing surface 184 can serve as a restraining surface for the pin 160 and can prevent the pin 160 from sliding out of the passage 150 of the first grommet 120. The second annular end flange 134 and the head 176 form a second restraint and once inserted into the first grommet 120 of the releasable fastener assembly 100, the pin 160 is reliably retained to the remainder of the releasable fastener assembly 100 and any danger of dropping and losing a small component can be mitigated.

Releasable fastener assembly 100 can be configured to define a loop 190 by folding the flexible strap 104 onto itself. The pin 160 can be inserted into the first grommet 120 prior to or after aligning the passage 150 of the first grommet 120 with the passage 150 of the second grommet 120. Prior to inserting the pin 160 into the second grommet 120, the loop 190 of the flexible strap 104 can envelop an equestrian device such as the bit 194. The passage 150 of a second grommet 120 can be aligned with the passage 150 of the first grommet 120 and the pin 160 can further be selectively inserted through the passage 150 of the second grommet 120. After the retractable latching mechanism 180 clears the generally cylindrical portion 136 of the second grommet 120, the generally cylindrical portion 136 no longer restrains the retractable latching mechanism 180 generally perpendicularly to a proximal-distal axis of the pin shaft 164, and the retractable latching mechanism 180 returns to its initial protruded state. The trailing surface 184 of the retractable latching mechanism 180 can abut the substantially flat portion 130 of the first annular end flange 124 of the second grommet 120. In this state, the trailing surface 184 can provide a restraining surface for the pin 160 and can cooperate with the substantially flat portion 130 of the first annular end flange 124 to prevent the pin 160 from sliding out of the passage 150. The second annular end flange 134 of the first grommet 120 can abut the pin head 176 to form a second restraint and the releasable fastener assembly 100 can be in its assembled state.

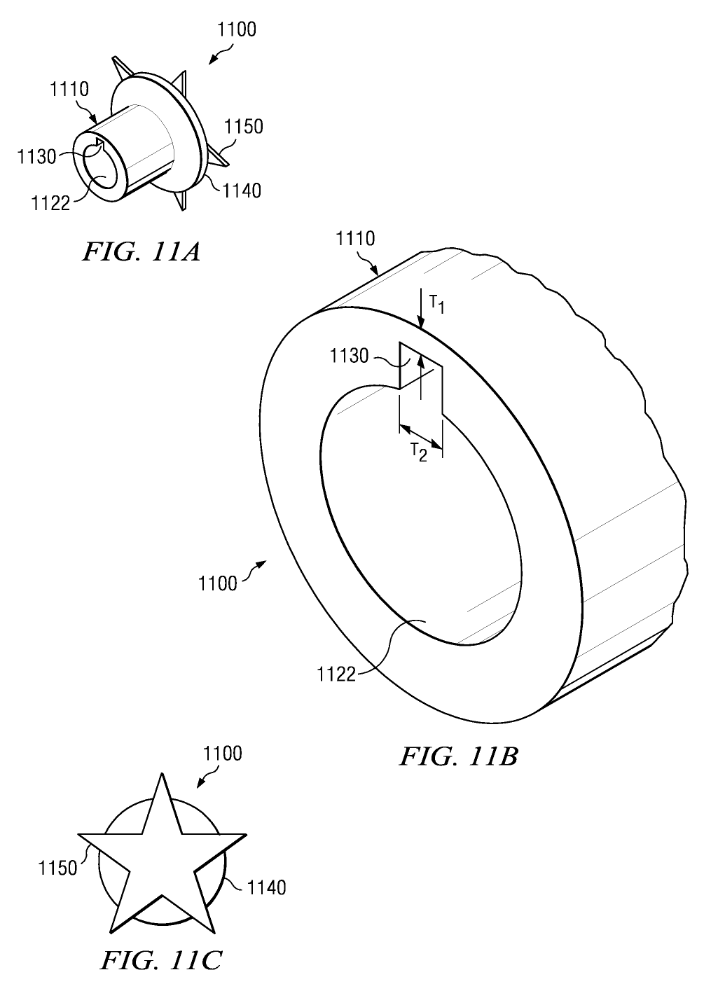

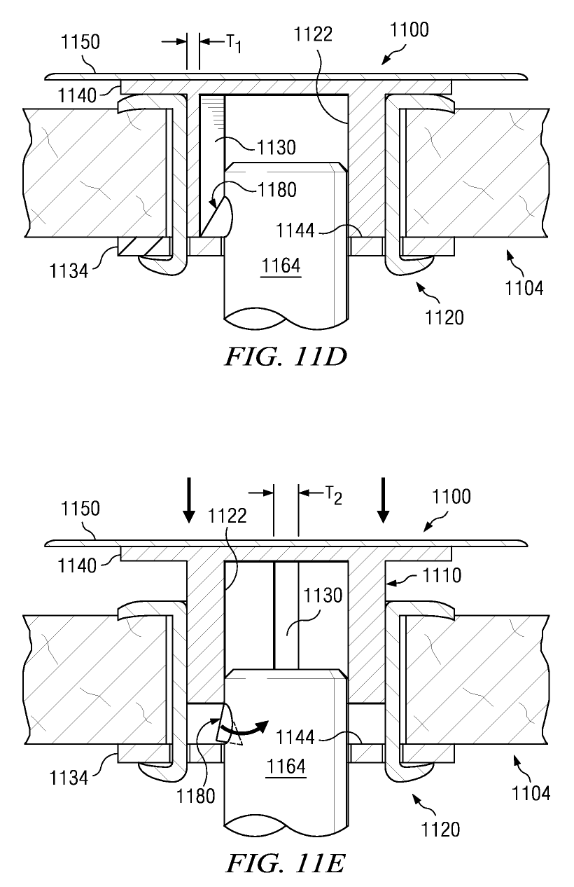

The releasable fastener assembly 100 can be unfastened by exerting force upon the retractable latching mechanism 180 to move the retractable latching mechanism 180 into the shaft 164 and pulling the pin 160 in the opposite direction of insertion. Depressing the retractable latching mechanism 180 can be accomplished manually or with a small tool such as that shown in FIG. 11A and discussed later. Once the pin 160 clears the passage 150 of the second grommet 120, the retractable latching mechanism 180 can once again return to its initial protruding state such that the trailing surface 184 of the retractable latching mechanism 180 abuts the substantially flat portion 130 of grommet 120.

Releasable fastener assembly 100 can include two or more apertures 108 in the flexible strap 104, and can be positioned in a variety of alignments that can provide loops 190 of different sizes with one assembly when the releasable fastener assembly 100 is fastened. Multiple sizes of the loop 190 can be achieved by including multiple apertures such as depicted in FIG. 10 and later discussed.

For this and other embodiments, a specific type of pin is depicted and discussed. Namely, a pin having a retractable latching mechanism that includes a substantially flat portion is disclosed. It should be noted that other types of pins with retractable latching mechanisms may be used in certain applications, such as a pin having a ball bearing that is biased in place by a resilient member. Similarly, it should be noted that although grommets having a substantially flat portion on an annular flange are shown and discussed in conjunction with the drawings, in certain contexts a traditional grommet having a rounded annular flange can be used.

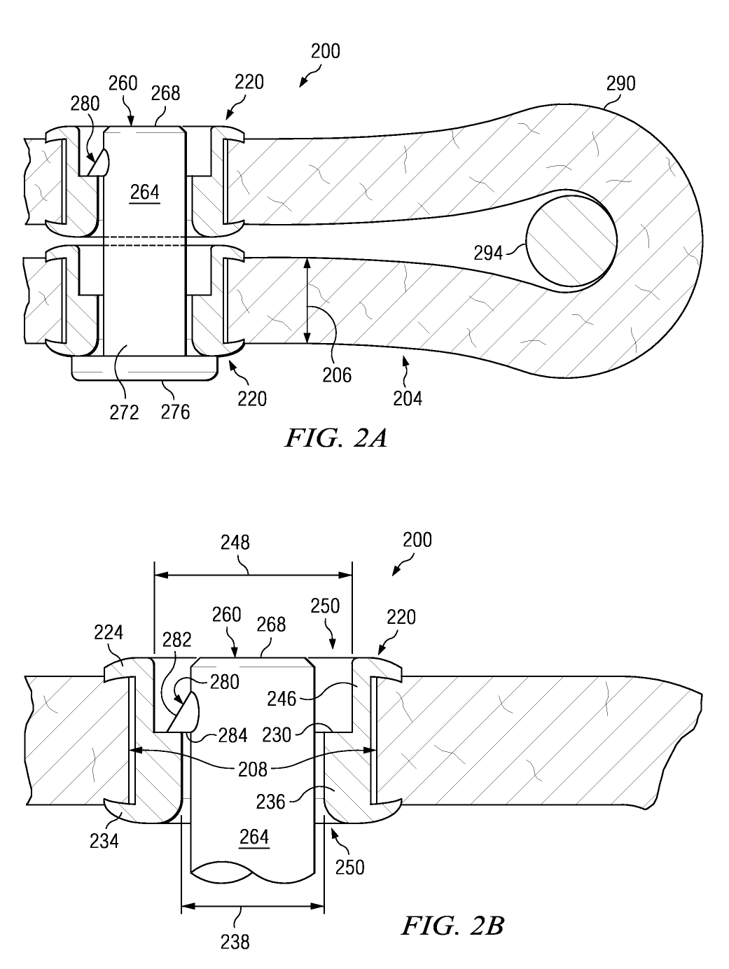

FIGS. 2A and 2B illustrate a releasable fastener assembly 200 according to another embodiment. Releasable fastener assembly 200 can include a single flexible strap 204 that can be configured to form a loop 290. Loop 290 in turn can be used to connect equestrian devices together, for example, a bit 294 can be connected to flexible strap 204 such that the movement of flexible strap 204 can then direct the bit 294. Flexible strap 204 can be made of leather or other flexible material such as natural or synthetic fabrics or another suitable material.

In the releasable fastener assembly 200, the flexible strap 204 defines a plurality of apertures 208. The apertures 208 can be formed by methods common in the art such as punching. The flexible strap 204 has a thickness 206. Each of the plurality of apertures 208 can extend through the thickness 206. Releasable fastener assembly 200 can include a plurality of grommets 220. Each of the grommets 220 can be positioned within a respective one of the apertures 208.

Grommet 220 can have a first annular end flange 224, a second annular end flange 234 opposite the first annular end flange 224 and a first generally cylindrical portion 236 and a second generally cylindrical portion 246 positioned between the first and second annular flanges 224, 234. The generally cylindrical portions 236 and 246 can cooperate to define a passage 250 through the grommet 220. Generally cylindrical portion 236 has a first inner diameter 238. Generally cylindrical portion 246 has a second inner diameter 248. The second inner diameter 248 can be different than the first inner diameter 238. The second inner diameter 248 can be greater than the first inner diameter 238 as shown in FIG. 2B. The first generally cylindrical portion 236 can include a substantially flat annular surface 230 within the passage 250. In this releasable fastener assembly 200, both the first annular end flange 224 and the second annular end flange 234 can engage the flexible strap 204.

The releasable fastener assembly 200 can also include a pin 260. The pin 260 has a shaft 264 that can be selectively insertable through the passage 250 of the grommet 220, as will be further discussed herein. The shaft 264 can have a proximal end 268 and a distal end 272. The pin 260 can have a head 276 integral with the distal end 272 of shaft 264. The head 276 can be larger than the shaft 264. The pin 260 can also include a retractable latching mechanism 280, positioned proximate to the proximal end 268 of the shaft 264. The retractable latching mechanism 280 can be spring-biased such that the retractable latching mechanism 280 protrudes in an initial state, but is capable of being moved such that the retractable latching mechanism 280 can be largely or substantially contained within the shaft 264. Selectively inserting the pin into the passage 250 can place pressure upon an angled leading surface 282 of retractable latching mechanism 280 to move the retractable latching mechanism 280 to a position (not shown) largely within the shaft 264 of the pin 260, thus allowing the pin 260 to clear a portion of the passage 250 related to the first inner diameter 238. A trailing surface 284 of the retractable latching mechanism 280 can serve as a restraining surface so that a force applied to the pin 260 cannot move the pin 260 out of position.

In this embodiment, the pin 260 can be selectively inserted into the passage 250 of the first grommet 220. After the retractable latching mechanism 280 clears the smaller first inner diameter 238 of the generally cylindrical portion 236, the generally cylindrical portion 236 no longer restrains the retractable latching mechanism 280 and the retractable latching mechanism 280 can return to its protruded initial state. In this state, while the releasable fastener assembly 200 is not in a completely fastened state, the trailing surface 284 of the retractable latching mechanism 280 can serve as a restraining surface for the pin 260 and can prevent the pin 260 from sliding out of the passage 250 of the first grommet 220. The second annular end flange 234 and the head 276 cooperate to form a second restraint and once inserted into the first grommet 220 of the releasable fastener assembly 200, the pin 260 can be retained to the remainder of the releasable fastener assembly 200.

Releasable fastener assembly 200 can be configured to define the loop 290 by folding the flexible strap 204 onto itself. The pin 260 can be inserted into the first grommet 220 prior to or after aligning the passage 250 of the first grommet 220 with the passage 250 of the second grommet 220. Prior to inserting the pin 260 into the second grommet 220, the loop 290 of flexible material can envelop an equestrian device such as bit 294. The passage 250 of a second grommet 220 can be aligned with the passage 250 of the first grommet 220 and the pin 260 can further be selectively inserted through the passage 250 of the second grommet 220. After the retractable latching mechanism 280 clears generally cylindrical portion 236, generally cylindrical portion 236 no longer restrains the retractable latching mechanism 280 generally perpendicularly to a proximal-distal axis of the pin shaft 264, and the retractable latching mechanism 280 can return to its protruded rest state. In this state, the trailing surface 284 of the retractable latching mechanism 280 can provide a restraining surface for the pin 260 and can prevent the pin 260 from sliding out of the passage 250. The trailing surface 284 of the retractable latching mechanism 280 can abut the substantially flat surface 230 of the second grommet 220. The second annular end flange 234 of the first grommet 220 can abut the pin head 276 to form a second restraint and the releasable fastener assembly 200 can be in its assembled state.

The releasable fastener assembly 200 can be unfastened by applying pressure to the retractable latching mechanism 280 to move the retractable latching mechanism 280 into the shaft 264 and pulling the pin 260 in the opposite direction of insertion. Depressing the retractable latching mechanism 280 can be accomplished manually or with a small tool such as the tool shown and described in conjunction with FIG. 11A. Once the pin 260 clears the generally cylindrical portion 236 of the second grommet 220, the retractable latching mechanism 280 can once again return to its initial protruding state.

Placement of substantially flat annular surface 230 can allow the pin proximal end 268 to rest below the top of the first annular end flange 224 when the releasable fastener assembly 200 is fastened. This can have the effect of having the pin 260 flush with or sunk below the first annular end flange 224. This can be desirable to avoid the proximal end 268 from digging into the flesh of a horse or other stock. Additionally, when the releasable fastener assembly 200 is used with equestrian devices, the proximal end 268 can be covered with additional material such as a flexible strap 204 used to close a loop that holds a buckle in place.

Releasable fastener assembly 200 can include two or more apertures 208 as defined in the flexible strap 204, and can be positioned in a variety of alignments that can provide loops 290 of different sizes with one assembly when the releasable fastener assembly 200 is fastened. Various loop sizes can be achieved by varying the space between the two apertures 208 or by using multiple apertures such as shown and described in conjunction with FIG. 10.

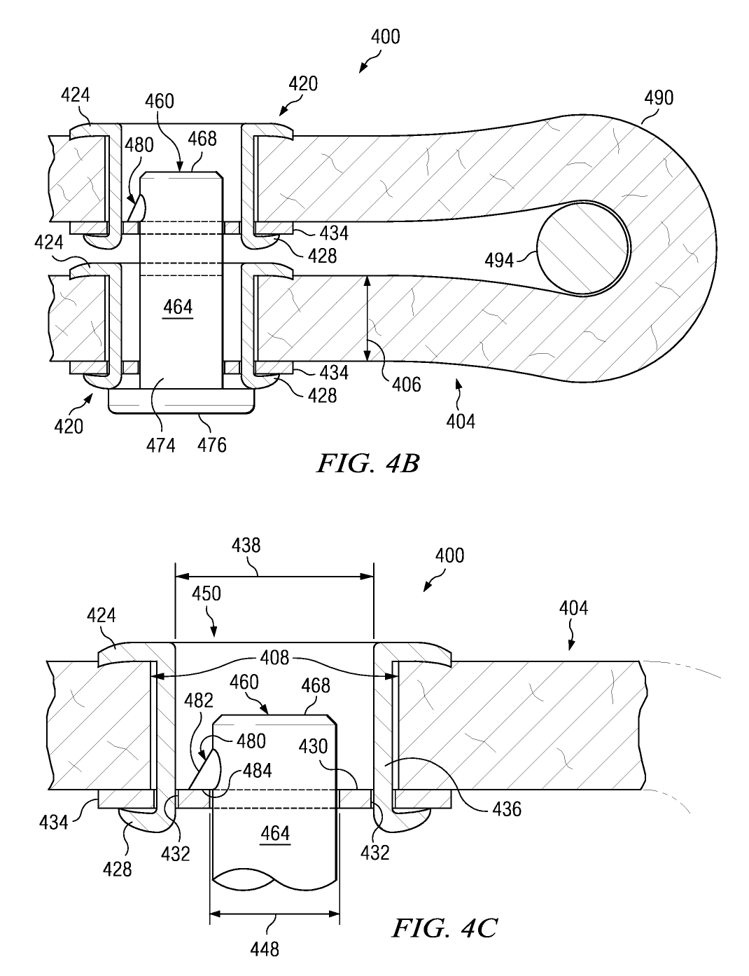

FIGS. 4A, 4B, and 4C illustrate a releasable fastener assembly 400 according to another embodiment. Releasable fastener assembly 400 can include a single flexible strap 404 that can be configured to form a loop 490. Loop 490 in turn can be used to connect equestrian devices together, for example, a bit 494 can be connected to flexible strap 404 such that the movement of flexible strap 404 can then direct the bit 494. Flexible strap 404 can be made of leather or other flexible material such as natural or synthetic fabrics or another suitable material.

In the releasable fastener assembly 400, the flexible strap 404 defines a plurality of apertures 408. The apertures 408 can be formed by methods common in the art such as punching. The flexible strap 404 has a thickness 406. Each of the plurality of apertures 408 can extend through the thickness 406. Releasable fastener assembly 400 can include a plurality of grommets 420. Each of the grommets 420 can be positioned in a respective one of the apertures 408.

Grommet 420 can have a first annular end flange 424, a second annular end flange 434 opposite the first annular end flange 424, and a generally cylindrical portion 436 extending between the first and second annular end flanges 424, 434. A plurality of tabs 428 extend from the generally cylindrical portion 436 and can engage with a plurality of passages 432 of the second annular end flange 434 to secure the second annular end flange 434 to the generally cylindrical portion 436 by bending or folding a portion of each of the plurality of tabs 428 that protrude from each of the passages 432.

Generally cylindrical portion 436 has a first inner diameter 438. The second annular end flange 434 has a second inner diameter 448. The generally cylindrical portions 436 and second inner diameter 448 of the second annular end flange 434 can define a passage 450 through the grommet 420. The second inner diameter 448 can be different than the first inner diameter 448. As shown in FIG. 4C, the second inner diameter 448 can be less than the first inner diameter 438. The second annular end flange 434 can include a substantially flat annular surface 444 within the passage 450. In this releasable fastener assembly 400, both the first annular end flange 424 and the second annular end flange 434 can engage the flexible strap 404.

The releasable fastener assembly 400 can also include a pin 460. Pin 460 can be the same as, or similar to, pins discussed previously. Other suitable pins can also be used.

In this embodiment, the pin 460 can be selectively inserted into the passage 450 of the first grommet 420. After the retractable latching mechanism 480 clears the second annular end flange 434, the second annular end flange 434 no longer restrains the retractable latching mechanism 480 and the retractable latching mechanism 480 can return to its initial protruded state. In this state, while the releasable fastener assembly 400 is not in a completely fastened state, the trailing surface 484 of the retractable latching mechanism 480 can serve as a restraining surface for the pin 460 and can prevent the pin 460 from sliding out of the passage 450 of the first grommet 420. The second annular end flange 434 and the head 476 cooperate to form a second restraint and once inserted into the first grommet 420 of the releasable fastener assembly 400, the pin 460 can be retained to the remainder of the releasable fastener assembly 400.

Releasable fastener assembly 400 can be configured to define a loop 490 by folding the flexible strap 404 onto itself. The pin 460 can be inserted into the first grommet 420 prior to or after aligning the passage 450 of the first grommet 420 with the passage 450 of the second grommet 420. Prior to inserting the pin 460 into the second grommet 420, the loop 490 of flexible strap 404 can envelop an equestrian device such as bit 494. The passage 450 of a second grommet 420 can be aligned with the passage 450 of the first grommet 420 and the pin 460 can further be selectively inserted through the passage 450 of the second grommet 420. After the retractable latching mechanism 480 clears the second annular end flange 434, the second annular end flange 434 can no longer restrain the retractable latching mechanism 480 generally perpendicularly to a proximal-distal axis of the pin shaft 464, and the retractable latching mechanism 480 can return to its initial protruded state. In this state, the trailing surface 484 can provide a restraining surface for the pin 460 and can prevent the pin 460 from sliding out of the passage 450. The trailing surface 484 of the retractable latching mechanism 480 can abut the substantially flat annular surface 430 of the second grommet 420. The second annular end flange 434 of the first grommet 420 can abut the pin head 476 to form a second restraint and the releasable fastener assembly 400 can be in its assembled state. The substantially flat annular surface 430 provides a contact surface for the trailing surface 480.

The releasable fastener assembly 400 can be unfastened by applying pressure to the retractable latching mechanism 480 to move the retractible latching mechanism 480 into the shaft 464 and pulling the flexible strap 404 in the direction of insertion. Depressing the retractable latching mechanism 480 can be accomplished manually or with a small tool such as the tool depicted and described in connection with FIG. 11A. Once the pin 460 clears the second annular end flange 434 of the second grommet 420, the retractable latching mechanism 480 can once again return to its initial protruding state.

Placement of substantially flat annular surface 430 can allow the pin proximal end 468 of shaft 464 of pin 460 to rest below the top of the first annular end flange 424 of second grommet 420 when the releasable fastener assembly 400 is fastened. This can have the effect of having the pin 460 flush with or sunk below the first annular end flange 424. This can be desirable to avoid the pin head 476 from digging into the flesh of a horse or other stock. When the releasable fastener assembly 400 is used with equestrian devices, the pin head 476 can be covered with additional material such as a flexible strap 404 used to close a loop that holds a buckle in place.

Releasable fastener assembly 400 can include two or more apertures 408 as defined in the flexible strap 404, and can be positioned in a variety of alignments that can provide loops 490 of different sizes with one assembly when the releasable fastener assembly 400 is fastened. Various loop sizes can be achieved by varying the space between the two apertures 408 or by using multiple apertures 408, such as illustrated and described in conjunction with FIG. 10.

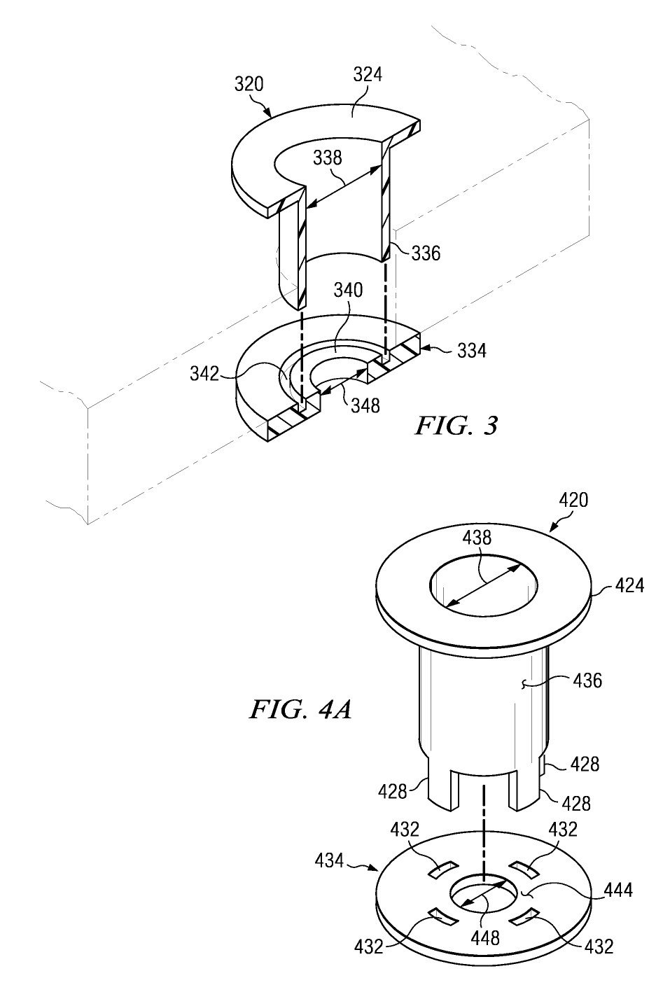

The grommet 420 can have various constructions and be made from various materials as recognized by those skilled in the art, such as brass. The grommet 420 as pictured in FIGS. 4B and 4C, is shown in greater detail in FIG. 4A. Alternate grommets, such as grommet 320 shown in FIG. 3, can be used in lieu of grommet 420. Grommet 420 can be supplied as a two piece grommet and can include the first annular end flange 424 which can be integrated with the generally cylindrical portion 436. The generally cylindrical portion 436 can have a first inner diameter 438. The generally cylindrical portion 436 has a plurality of tabs 428 opposite the first annular end flange 424. The second annular end flange 434 can have a plurality of passages 432 that can align with the plurality of tabs 428. The plurality of tabs 428 can be inserted through the plurality of passages 432 in the second annular end flange 434. The second annular end flange 434 can have a substantially flat annular surface 430 and second inner diameter 448. Second inner diameter 448 can substantially align with first inner diameter 438. When grommet 420 is installed, each of the plurality of tabs 428 can be peened and pressed into second annular end flange 434.

Grommet 320 of FIG. 3 can also be supplied as a two piece grommet and can include a first annular end flange 324 and an integrated generally cylindrical portion 336. The generally cylindrical portion 336 can have a first inner diameter 338. The second annular end flange 334 can have a channel 342 that can substantially align with the generally cylindrical portion 336 opposite the first annular end flange 324. The second annular end flange 334 can have a substantially flat annular surface 340 and second inner diameter 348. Second inner diameter 348 can be substantially centered on the same axis as the first inner diameter 338. Grommet 320 can be integrated into a single piece prior to positioning in an aperture 408 or afterwards. Grommet 320 can be attached to generally cylindrical portion 336 by any suitable technique known in the art, such as spin welding or the use of a solvent to weld the second annular end flange 320 and cylindrical portion 336 inseparably to each other.

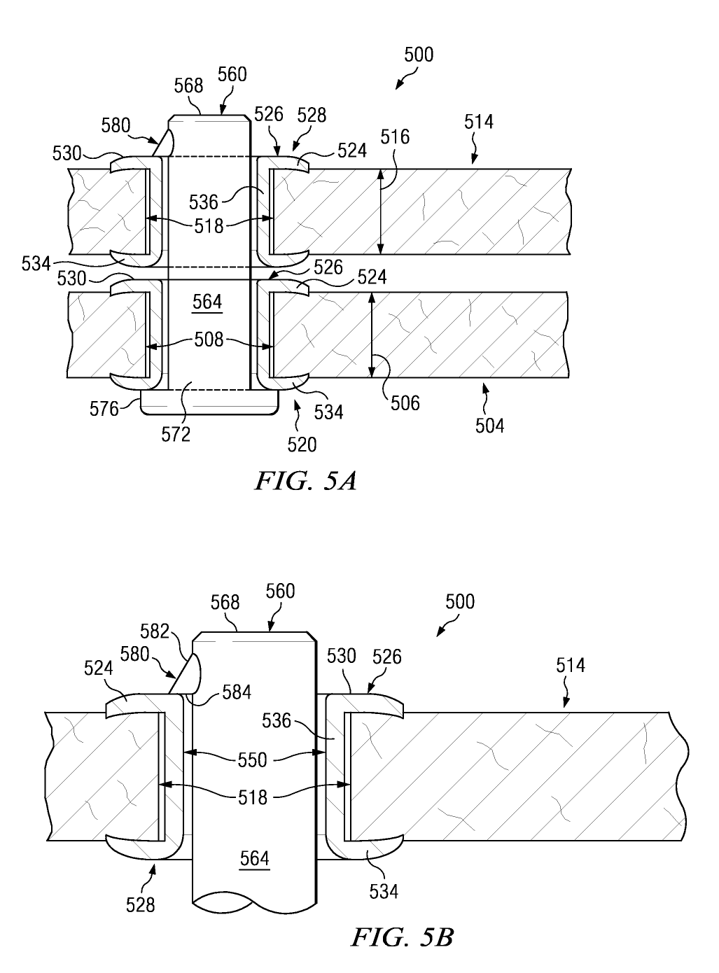

FIGS. 5A and 5B illustrate a releasable fastener assembly 500 according to another embodiment. Releasable fastener assembly 500 can include a plurality of flexible straps 504, 514. Each of the plurality of flexible straps 504, 514 has a respective thickness 506, 516. Apertures 508, 518 of the plurality of flexible straps 504, 514 each have a respective grommet 520, 528.

Releasable fastener assembly 500 is similar to the releasable fastener assembly 100 depicted in FIGS. 1A, 1B, and 1C with the exception that the plurality of straps 504, 514 are used instead of a single strap folded back upon itself to define a loop. The plurality of flexible straps 504, 514 can be made of leather or other flexible material such as natural or synthetic fabrics or another suitable material. Any of the previously discussed grommets, pins, and other components discussed in conjunction with the embodiment illustrated in FIGS. 1A, 1B, and 1C can be used in conjunction with releasable fastener assembly 500 to releasably fasten one of the plurality of straps 504 to another of the plurality of straps 514. The plurality of straps 504, 514 can be used to secure riding tack or other items such as saddles or bags.

In this embodiment, the pin 560 can be selectively inserted into the passage 550 of the first grommet 520. After the retractable latching mechanism 580 clears the generally cylindrical portion 536, the generally cylindrical portion 536 no longer restrains the retractable latching mechanism 580 and the retractable latching mechanism 580 returns to its initial protruded state. In this state, while the releasable fastener assembly 500 is not in a completely fastened state, the trailing surface 584 of the retractable latching mechanism 580 can serve as a restraining surface for the pin 560 and can prevent the pin 560 from sliding out of the passage 550 of the first grommet 520. The second annular end flange 534 and the head 576 cooperate to form a second restraint and once inserted into the first grommet 520 of the releasable fastener assembly 500, the pin 560 is retained to the remainder of the releasable fastener assembly 500.

The releasable fastener assembly 500 can be unfastened by exerting force upon the retractable latching mechanism 580 to move the retractable latching mechanism 580 into the shaft 564 and pulling the flexible strap 514 in the direction of insertion. Depressing the retractable latching mechanism 580 can be accomplished manually or with a small tool such as the tool depicted and described in conjunction with FIG. 11A. Once the pin 560 clears the passage 550 of the second grommet 528, the retractable latching mechanism 580 can once again return to its initial protruding state.

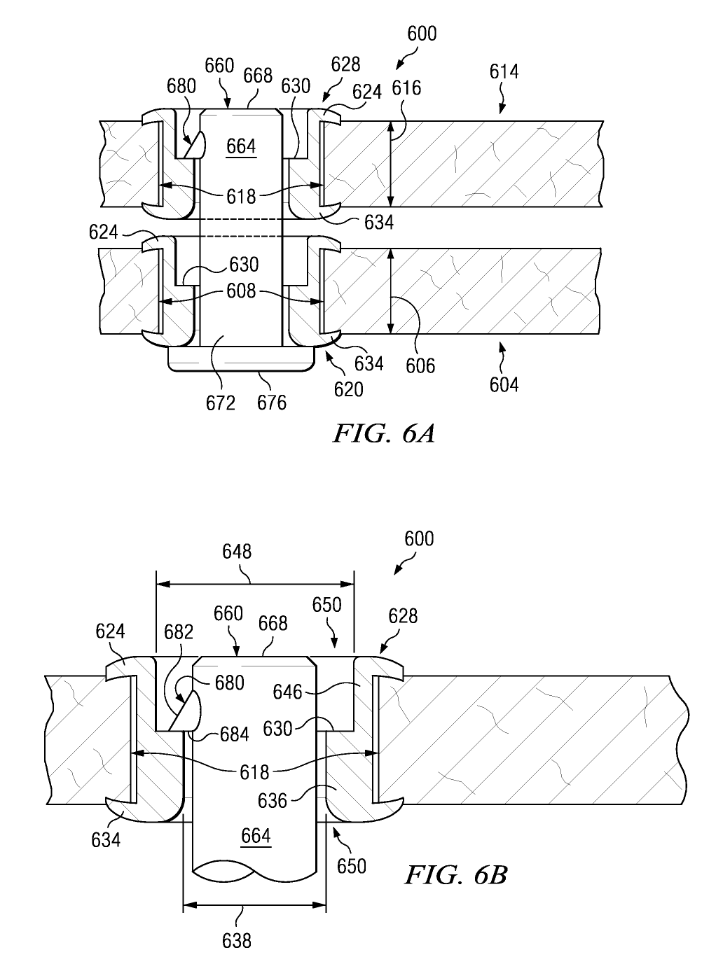

FIGS. 6A and 6B illustrate an embodiment of a releasable fastener assembly 600 according to one embodiment. Releasable fastener assembly 600 is similar to the releasable fastener assembly 200 depicted in FIGS. 2A and 2B with the exception that a plurality of straps 604, 614 are used instead of a single strap folded back upon itself to define a loop. The plurality of flexible straps 604, 614 can be made of leather or other flexible material such as natural or synthetic fabrics or another suitable material. Any of the previously discussed grommets, pins, and other components discussed in conjunction with the embodiment illustrated in FIGS. 2A and 2B can be used in conjunction with releasable fastener assembly 600 to releasably fasten one of the plurality of straps 604 to another of the plurality of straps 614. The plurality of straps 604, 614 can be used to secure riding tack or other items such as saddles or bags.

The pin 660 has a shaft 664 that can be selectively insertable through the passage 650 of the grommets 620 and 628 respectively, as will be further discussed herein. The shaft 664 can have a proximal end 668 and a distal end 672. The pin 660 can have a head 676 integral with pin distal end 672 of shaft 664. The head 676 can be larger than the shaft 664. The pin 660 can include a retractable latching mechanism 680, positioned proximate to the proximal end 668 of the shaft 664. The retractable latching mechanism 680 can be spring-biased such that the retractable latching mechanism 680 protrudes in an initial state, but is capable of being moved such that the retractable latching mechanism 680 can be largely or substantially contained within the shaft 664. Selectively inserting the pin into the passage 650 can exert pressure on an angled leading surface 682 of retractable latching mechanism 680 and can move the retractable latching mechanism 680 to the position (not shown) largely within the shaft 664 of the pin 660, thus allowing the pin 660 to clear a portion of the passage 650 related to the first inner diameter 638. A trailing surface 684 of the retractable latching mechanism 680 can serve as a restraining surface so that a force applied to the trailing surface 684 cannot move the retractable latching mechanism 680 to the position largely within the shaft 664 of the pin 660.

The releasable fastener assembly 600 can be unfastened by depressing the retractable latching mechanism 680 into the shaft 664 and pulling the flexible strap 614 in the direction of insertion. Depressing the retractable latching mechanism 680 can be accomplished manually or with a small tool such as the tool depicted and described in conjunction with FIG. 11A. Once the pin 660 clears the generally cylindrical portion 636 of the second grommet 628, the retractable latching mechanism 680 can once again return to its initial protruding state.

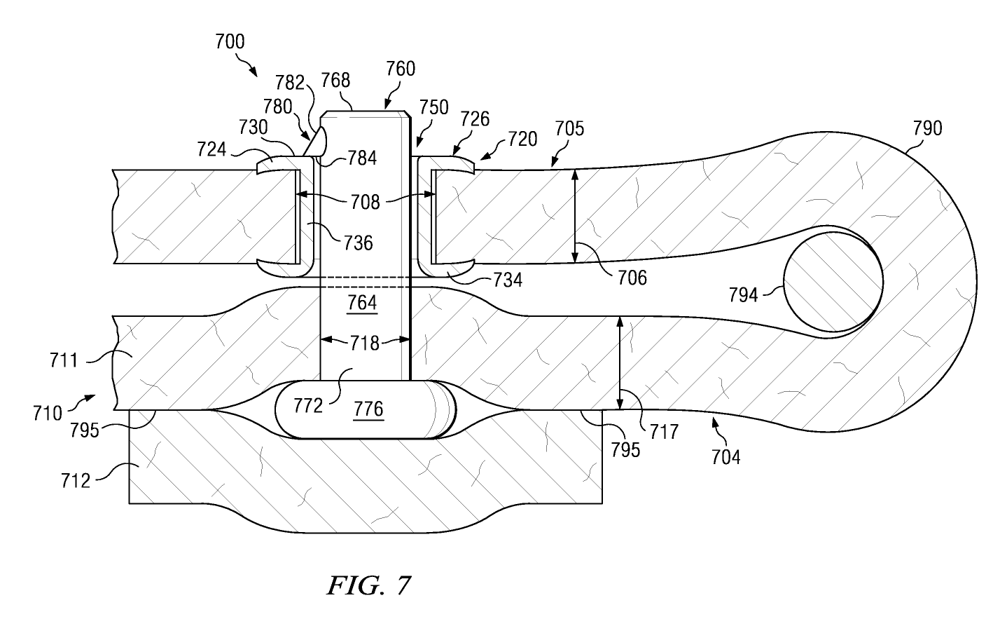

FIG. 7 illustrates an embodiment of a releasable fastener assembly 700 according to one embodiment. Releasable fastener assembly 700 can include a single flexible strap 704 that can be configured to form a loop 790. Loop 790 in turn can be used to connect equestrian devices together, for example, a bit 794 can be connected to flexible strap 704 such that the movement of flexible strap 704 that can then direct the bit 794. Flexible strap 704 can be made of leather or other flexible material such as natural or synthetic fabrics or another suitable material. Flexible strap 704 can include a first portion 705 and a second portion 710. Second portion 710 can include a first layer 711. The first layer 711 can have a first layer thickness 717. First layer 711 can define a second aperture 718. Second aperture 718 can extend through first layer thickness 717, and can be sized as discussed herein.

In the releasable fastener assembly 700, the first portion 705 of the flexible strap 704 can define a plurality of first apertures 708. For clarity, the discussion will focus on a single first aperture 708. The plurality of first apertures 708 can be formed by methods common in the art such as by punching. The first portion 705 of flexible strap 704 has a thickness 706. Each of the plurality of first apertures 708 can extend through the thickness 706. Releasable fastener assembly 700 can include a plurality of grommets 720. Each of the grommets 720 can be positioned within a respective one of the plurality of first apertures 708.

The grommet 720 can have a first annular end flange 724, a second annular end flange 734 opposite the first annular end flange 724 and a generally cylindrical portion 736 extending between the first 724 and second annular end flanges 734. The generally cylindrical portion 736 defines a passage 750 through the grommet 720. Each of the first annular end flange 724 and the second annular end flange 734 can engage the flexible strap 704. The first annular end flange 724 can have an outer surface 726 that can include a substantially flat portion 730.

The releasable fastener assembly 700 can also include a pin 760. Suitable pins that can be used as pin 760 have been discussed previously in conjunction with other drawings. Additionally, pin 760 is described in detail below.

The pin 760 has a shaft 764 that can be selectively insertable through the passage 750 of the grommet 720. The shaft 764 can have a proximal end 768 and a distal end 772. The pin 760 can have a head 776 integral with pin distal end 772 of shaft 764. The head 776 can be larger than the shaft 764. The pin 760 can include a retractable latching mechanism 780, positioned proximate to the proximal end 768 of the shaft 764. The retractable latching mechanism 780 can be spring-biased such that the retractable latching mechanism 780 protrudes in an initial state, but is capable of being moved such that the retractable latching mechanism 780 can be largely or substantially contained within the shaft 764. Selectively inserting the pin into the passage 750 can apply pressure to an angled leading surface 782 of retractable latching mechanism 780 and can move the retractable latching mechanism 780 to the position (not shown) largely within the shaft 764 of the pin 760, thus allowing the pin 760 to clear the passage 750. A trailing surface 784 of the retractable latching mechanism 780 can serve as a restraining surface as a force applied to the trailing surface 784 cannot move the retractable latching mechanism 780 to the position largely within the shaft 764 of the pin 760.

In this embodiment, the pin 760 can be captured between first layer 711 and second layer 712 in the second portion 710 of flexible strap 704. Second aperture 718 can be sized to accommodate shaft 764. Pin head 776 can be sized to be larger than second aperture 718; conversely, second aperture 718 can be sized to be smaller than head 776. The proximal end 768 of pin 760 can be press fit and extended through the second aperture 718. Head 776 can prevent the pin 760 from completely moving through second aperture 718. First layer 711 and second layer 712 can then be affixed to each other by methods known to those of skill in the art such as by sewing or using adhesives such as glues or other suitable bonding agents.

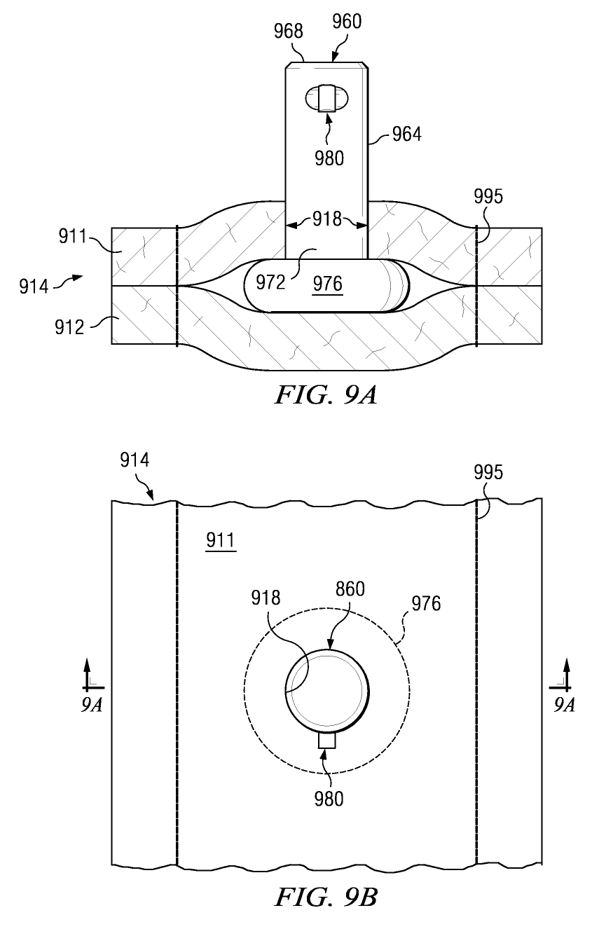

Briefly looking at FIGS. 9A and 9B, a manner in which sewing can be employed is illustrated. Stitching 995 can be used after a proximal end 968 of a shaft 964 of a pin 960 has been press fit and extended through a second aperture 918 of a first layer 911 of a flexible strap 914. The pin 960 can have a retractable latching mechanism 980 located proximate to the proximal end 968. The shaft 964 can also have a pin distal end 972 and a head 976 integral with pin distal end 972. The head 976 can be captured between the first layer 911 and a second layer 912 prior to the application of stitching 995.

Returning to FIG. 7, a manner in which an adhesive 795 can be used between first layer 711 and second layer 712 to affix the two layers together. Adhesive 795 can be a glue or other suitable agent for bonding whatever material was used to make straps 704, 714. Other appropriate techniques as may be known to those in the art can be utilized.

Releasable fastener assembly 700 can be configured to define a loop 790 by folding the flexible strap 704 onto itself and aligning the passage 750 with the pin 760. Prior to inserting the pin 760 into the second grommet 720, the loop 790 of flexible strap 704 can envelop an equestrian device such as bit 794. Pin 760 can be selectively inserted into the passage 750 of grommet 720. After the retractable latching mechanism 780 clears the generally cylindrical portion 736, the generally cylindrical portion 736 no longer restrains the retractable latching mechanism 780 and the retractable latching mechanism 780 returns to its initial state. In this state, the trailing surface 784 of the retractable latching mechanism 780 can serve as a restraining surface for the pin 760 and can prevent the pin 760 from sliding out of the passage 750 of grommet 720. The retractable latching mechanism 780 can abut the substantially flat portion 730 of the first annular end flange 724 of grommet 720. Head 776 can be restrained as being captured between first layer 711 and second layer 712 and the releasable fastener assembly 700 can be in its assembled state.

The releasable fastener assembly 700 can be unfastened by moving the retractable latching mechanism 780 into the shaft 764 and pulling the first portion 705 in the direction of insertion. Depressing the retractable latching mechanism 780 can be accomplished manually or with a small tool such as the tool illustrated and described in conjunction with FIG. 11A. Once the pin 760 clears the passage 750 of grommet 720, the retractable latching mechanism 780 can once again return to its initial protruding state.

Releasable fastener assembly 700 can include two or more apertures 708 as defined in the flexible strap 704, and can be positioned in a variety of alignments that can provide loops 790 of different sizes with one assembly when the releasable fastener assembly 700 is fastened. Various loop sizes can be achieved by varying the space between a plurality of apertures 708 or by using multiple apertures such as shown and described in conjunction with FIG. 10. Each embodiment can have particular value to users of the disclosed releasable fastener assembly 700.

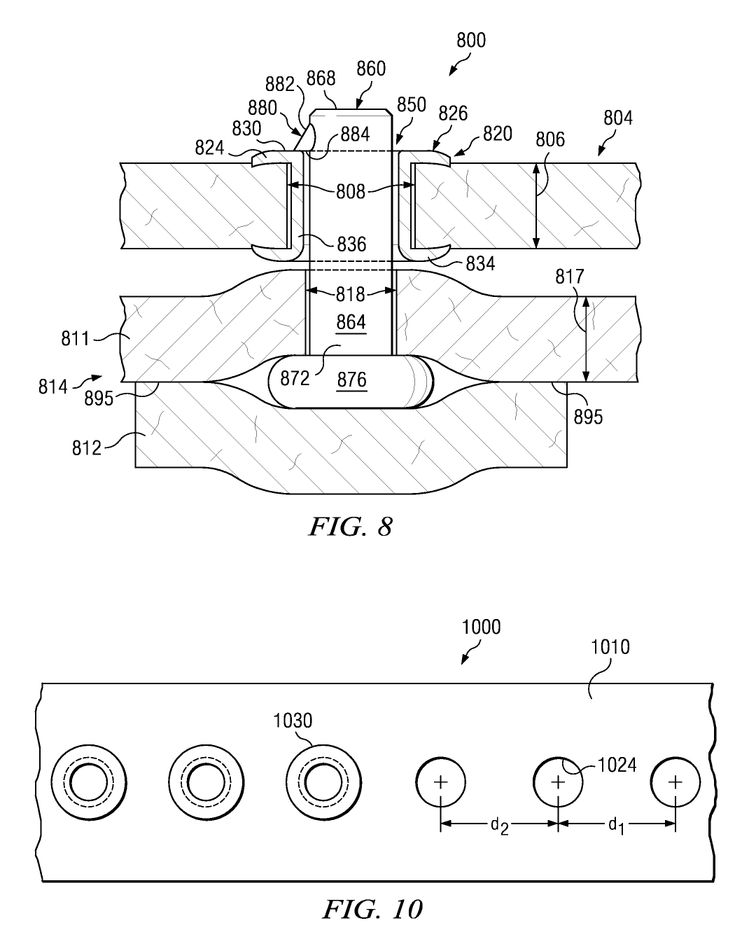

FIG. 8 illustrates an embodiment of a releasable fastener assembly 800 according to one embodiment. Releasable fastener assembly 800 is similar to the releasable fastener assembly 700 depicted in FIG. 7 with the exception that a plurality of straps 804, 814 are used instead of a single strap folded back upon itself to define a loop. The plurality of flexible straps 804, 814 can be made of leather or other flexible material such as natural or synthetic fabrics or another suitable material. Any of the previously discussed grommets, pins, and other components can be used in conjunction with releasable fastener assembly 800 to releasably fasten one of the plurality of straps 804 to another of the plurality of straps 814. The plurality of straps 804, 814 can be used to secure riding tack or other items such as saddles or bags.

The releasable fastener assembly 800 can also include a pin 860. Suitable pins that can be used as pin 860 have been discussed previously in conjunction with other drawings. Additionally, details of pin 860 are provided below.

The pin 860 has a shaft 864 that can be selectively insertable through the passage 850 of the grommet 820. The shaft 864 can have a proximal end 868 and a distal end 872. The pin 860 can have a head 876 integral with pin distal end 872 of shaft 864. The head 876 can be larger than the shaft 864. The pin 860 can include a retractable latching mechanism 880, positioned proximate to the proximal end 868 of the shaft 864. The retractable latching mechanism 880 can be spring-biased such that the retractable latching mechanism 880 protrudes in a rest state, but is capable of being moved such that the retractable latching mechanism 880 can be largely or substantially contained within the shaft 864. Selectively inserting the pin into the passage 850 can apply pressure to an angled leading surface 882 of retractable latching mechanism 880 and can move the retractable latching mechanism 880 to the position (not shown) largely within the shaft 864 of the pin 860, thus allowing the pin 860 to clear the passage 850. A trailing surface 884 of the retractable latching mechanism 880 can serve as a restraining surface as a force applied to the trailing surface 884 cannot move the retractable latching mechanism 880 to the position largely within the shaft 864 of the pin 860.

In this embodiment, the pin 860 can be captured between first layer 811 and second layer 812 in the second portion 810 of flexible strap 814. Second aperture 818 can be sized to accommodate shaft 864. Pin head 876 is sized to be larger than second aperture 818; conversely, second aperture 818 is sized to be smaller than head 876. The proximal end 868 of pin 860 can be press fit and extended through the second aperture 818. Head 876 can prevent the pin 860 from completely moving through second aperture 818. First layer 811 and second layer 812 can then be affixed to each other by methods known to those of skill in the art such as sewing or using adhesives such as glue or other appropriate bonding agents.

Briefly looking at FIGS. 9A and 9B, a manner in which sewing can be undertaken is illustrated. Stitching 995 can be used after a proximal end 968 of a shaft 964 of a pin 960 has been press fit and extended through a second aperture 918 of a first layer 911 of a flexible strap 914. The pin 960 can have a retractable latching mechanism 980 located proximate to the proximal end 968. The shaft 964 can also have a pin distal end 972 and a head 976 integral with pin distal end 972. The head 976 can be captured between the first layer 911 and a second layer 912 prior to the application of stitching 995.

Returning to FIG. 8, an adhesive 895 can be used between first layer 811 and second layer 812 to affix the two layers together. Adhesive 895 can be a glue or other suitable agent for bonding whatever material was used to make straps 804, 814. Other appropriate techniques as may be known to those in the art can be utilized.

The releasable fastener assembly 800 can be unfastened by depressing the retractable latching mechanism 880 into the shaft 864 and pulling the first flexible strap 804 in the direction of insertion. Depressing the retractable latching mechanism 880 can be accomplished manually or with a small tool such as the tool depicted and described in conjunction with FIG. 11A. Once the pin 860 clears the passage of grommet 820, the retractable latching mechanism 880 can once again return to its initial protruding state. Releasable fastener assembly 800 can include two or more apertures 808 (not shown) as defined in the flexible strap 814, and can be positioned in a variety of alignments with one assembly when the releasable fastener assembly 800 is fastened.

It is to be understood that in the embodiments presented herein, a single grommet or aperture can be discussed for clarity, while an ordinary person of skill in this art will recognize that the embodiments can equally cover a plurality of grommets and apertures. Turning to FIG. 10, a generalized embodiment 1000 shows a flexible strap 1010, which, for example, can be a leather strap. The flexible strap 1010 can define a plurality of apertures 1024 spaced apart from each other, for example first spacing d1. Spacing can vary according to desired purpose of the equestrian device, for example, second spacing d2 can be different than first spacing d1. Within each of the plurality of apertures, a grommet 1030 can be positioned, and each of the plurality of grommets can engage the flexible strap 1010. Each of the plurality of grommets 1030 can be an embodiment disclosed herein, for example, grommet 120, grommet 220, or grommet 320. The grommet can be supplied as single piece, such that a first annular end flange (not shown) and a grommet second annular end flange (not shown) and generally cylindrical portion (not shown) are integrated. The grommet 1030 can also supplied as multiple pieces, for example, a first annular end flange can be integrated with a generally cylindrical portion and a second annular end flange can be supplied as a second piece. Moreover, the grommets can be of different material such as suitable plastic materials or metal.

A method for attaching a grommet to a flexible strap includes creating a plurality of apertures in a flexible strap. Creating the plurality of apertures can be done by punching or other methods known by a person skilled in the art.

Each one of a plurality of grommets can be positioned into a respective one of the plurality of apertures. Each grommet can be supplied in a variety of configurations and materials and can include a first annular end flange, a second annular end flange opposite the first annular end flange, and a generally cylindrical portion, the generally cylindrical portion extending between the first annular end flange and the second annular end flange. The generally cylindrical portion can define a passage of the grommet, or in cooperation with an annular end flange can define a passage extending through the grommet. The first annular end flange can include an outer surface, which has a substantially flat portion. A grommet or a plurality of grommets can be engaged to the flexible strap in such a manner as to create the substantially flat portion of a first annular end flange of each grommet. This can be accomplished with a modified crimp or rivet press wherein a conventional cup portion of part of the tool can be replaced by a substantially flat portion and an outer annular cupped section, thus providing both the desired engagement with the flexible strap as well as the substantially flat portion.

A typical die press assembly for fastening grommets of the type discussed herein includes a pair of cupped portions that are substantially mated with rounded annular flanges of grommets with which each die is intended to be used. Grommets typically include such rounded annular flanges as a consequence of manufacturing processes used to create the grommets. Consequently, it is necessary to flatten the rounded annular flange to create a substantially flat surface on the annular flange of the grommet.

To Flatten the annular flange, one of the sides of a conventional die press can be modified so that the side is substantially flat instead of cupped to mate with the rounded annular flange of the grommet. In use, the substantially flat portion of the die contacts the rounded annular flange of the grommet to deform and flatten the rounded annular flange. The amount of pressure needed to deform and flatten the rounded annular flange will vary according to such factors as size and material properties, but is within normal limits of ranges of pressure typically exerted when using conventional dies to affix conventional grommets.

FIGS. 1A through 11E illustrate a decorative cap 1100 that can be used in a releasable fastening assembly to cover the proximal end of a pin (not shown) such as for example pin 260 or pin 360 or other pins used in embodiments disclosed herein. The cap 1100 can be made of a resilient material, such as a suitable plastic. The cap 1100 can have a cylindrical portion 1110 with a central cylindrical bore 1120. The bore 1120 can be a light press fit to the proximal end of the pin. Such a press fit can provide for a manual fitting and easy removal of the cap 1100 from the pin and yet provide sturdiness for the cap 1100 to be able to stay in place through most use.

The bore 1120 can be relieved by a slot 1130 which is proportioned to loosely receive a retractable latching mechanism, such as for example retractable latching mechanism 280. Dimensions T1 and T2 can provide a non-interference slot for the retractable latching mechanism.

The cap 1100 can be used as a tool to unfasten the releasable fastening assembly. FIG. 11D and FIG. 11E illustrate this use. FIG. 11D illustrates a cap 1100 fitted to a pin shaft 1164 as a retractable latching mechanism 1180 abuts a substantially flat annular surface within a passage of a grommet 1120. Slot 1130 can prevent the inadvertent release of the releasable fastening assembly. FIG. 11E illustrates how the cap 1100 can be used to unfasten the releasable fastening assembly. In this view the cap 1100 can be removed from the position illustrated in FIG. 11D and rotated appropriately, for example 90 degrees, and refitted onto the pin shaft 1164. The bore 1120 presses on the leading surface of the retractable latching mechanism 1180 and can exert sufficient force to move the retractable latching mechanism 1180 largely with the shaft 1164, removing the abutment and allowing the pin to release.

The cap 1100 can have a head 1140 and can be ornamented in a desirable manner, such as with a star 1150. The decoration can be a variety of aesthetically pleasing designs.

What has been described above includes examples. It is, of course, not possible to describe every conceivable combination of components or methodologies for purposes of describing the disclosed systems and methods, but one of ordinary skill in the art can recognize that many further combinations and permutations are possible.

In addition, while a particular feature may have been disclosed with respect to only one of several implementations, such feature can be combined with one or more other features of the other implementations as can be desired and advantageous for any given or particular application. Furthermore, to the extent that the terms “includes,” and “including” and variants thereof are used, these terms are intended to be inclusive in a manner similar to the term “comprising.”

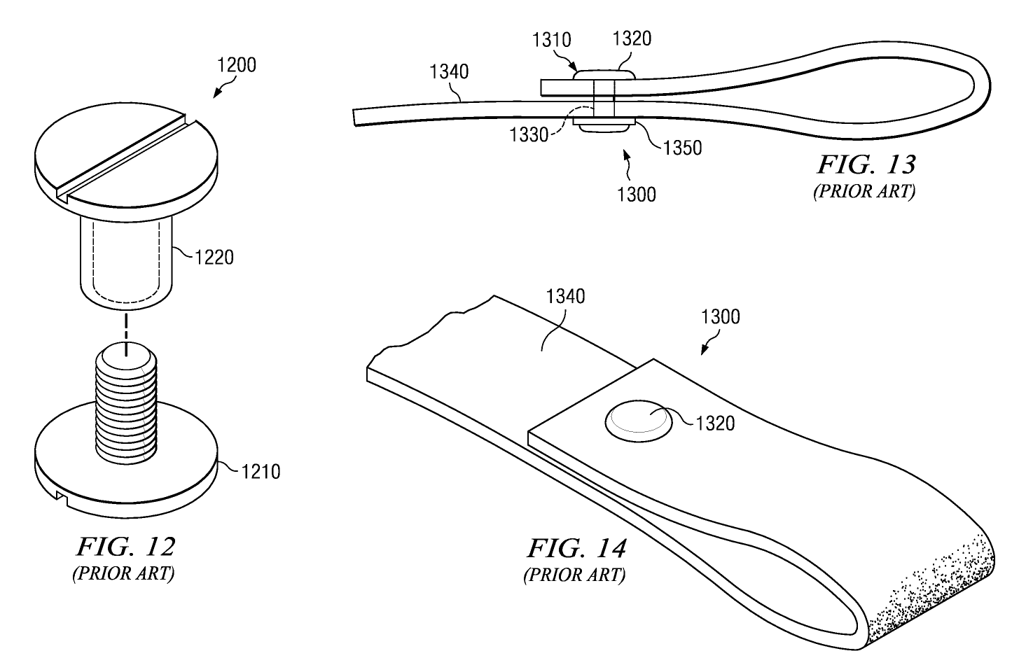

FIGS. 12 through 16 illustrate prior art fastening assemblies. Conventionally a grommet cannot be considered a fastening device in itself, rather a grommet can be a component in fastening assembly and can serve to protect or reinforce the substrate or a fastening item, for example a shoelace that runs through an aperture. A grommet or eyelet can also be attached to a flexible piece of material in a conjunction with a common fastening system such as tying, which can be considered similar to sewing. Sewing generally does not use grommets to protect or reinforce the substrate or protect the tying material.

An illustration of a prior art releasable fastening assembly is provided in FIGS. 12-14. A conventional fastening method in the equestrian arts is the use of a matching screw set, commonly referred to as a Chicago screw system 1200. The Chicago screw system includes a bolt 1210 with a specially configured nut 1220. The nut is an internally threaded tube or collate with a head on it. FIG. 13 depicts a single strap of material 1340 that is folded back upon itself to define a loop. A Chicago screw set 1310 includes a first head 1320 attached to a threaded bolt (not shown). A second head 1350 is attached to a threaded collar 1330. The threaded collar 1330 extends through apertures in the strap of material 1340. Additional detail is shown in a perspective view in FIG. 14.

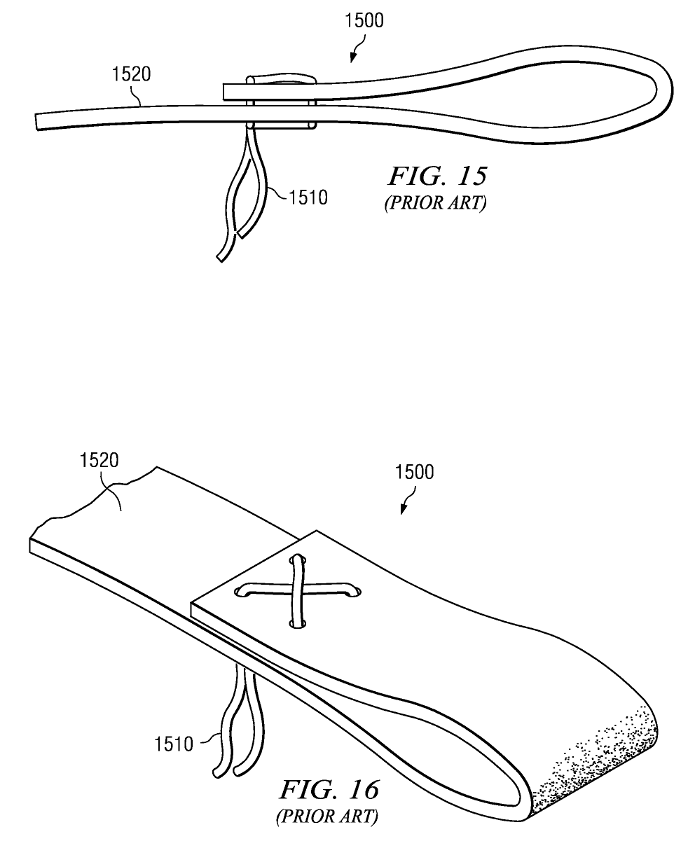

FIGS. 15 and 16 illustrate another prior art releasable fastening system 1500. This system is relatively simple, as all that is required is a strap 1520 and a leather band 1510. The leather band can be woven through aligned holes in a strap 1520 to secure a loop. While this fastening technique is reversible so that the rein could be removed from a bit, the process can be considered unduly laborious and slow.

What is claimed is:

1. A releasable fastener assembly comprising:
a flexible strap having a thickness, the flexible strap defining a plurality of apertures, each of the apertures extending through the thickness of the strap;
a plurality of grommets, each of the plurality of grommets being positioned in one of the plurality of apertures of the flexible strap and engaged with the flexible strap, each of the plurality of grommets comprising
a first annular end flange, the first annular end flange comprising
an outer surface, the outer surface comprising a substantially flat portion,
a second annular end flange opposite the first annular end flange, and
a generally cylindrical portion, the generally cylindrical portion extending between the first annular end flange and the second annular end flange and defining a passage extending through the grommet; and
a pin comprising
a shaft, the shaft comprising a proximal end and a distal end,
a head integral with the distal end of the shaft, and
a retractable latching mechanism positioned proximate to the proximal end of the shaft;
wherein the flexible strap is configured to define a loop such that the passage of a first one of the plurality of grommets is aligned with the passage of a second one of the plurality of grommets,
the pin is selectively insertable through the passage of the first one of the plurality of grommets and through the passage of the second one of the plurality of grommets, and
the head of the pin abuts the second annular flange of the first one of the plurality of grommets and the retractable latching mechanism abuts the substantially flat portion of the outer surface of the first annular flange of the second one of the plurality of grommets when the pin is inserted through the passage of each of the first and the second ones of the plurality of grommets.

2. A releasable fastener assembly comprising:
a flexible strap having a thickness, the flexible strap defining a plurality of apertures, each of the apertures extending through the thickness of the strap;
a plurality of grommets, each of the plurality of grommets being positioned in one of the plurality of apertures of the flexible strap and engaged with the flexible strap, each of the plurality of grommets comprising
a first annular end flange,
a second annular end flange opposite the first annular end flange,
a first generally cylindrical portion with a first inner diameter,
a second generally cylindrical portion with a second inner diameter, the second inner diameter greater than the first inner diameter,
the first and second inner diameters cooperating to define a passage extending through the grommet, and
the first generally cylindrical portion comprising a substantially flat annular surface within the passage; and
a pin comprising
a shaft, the shaft comprising a proximal end and a distal end,
a head integral with the distal end of the shaft, and
a retractable latching mechanism positioned proximate to the proximal end of the shaft;
wherein the flexible strap is configured to define a loop such that the passage of a first one of the plurality of grommets is aligned with the passage of a second one of the plurality of grommets,
the pin is selectively insertable through the passage of the first one of the plurality of grommets and through the passage of the second one of the plurality of grommets, and
the head of the pin abuts the second annular flange of the first one of the plurality of grommets and the retractable latching mechanism abuts the substantially flat annular surface when the pin is inserted through the passage of each of the first and the second ones of the plurality of grommets.

3. The releasable fastener assembly of claim 2, wherein the proximal end of the shaft is located between the first and second annular end flanges of the second one of the plurality of grommets when the pin is inserted through the passage of each of the first and the second ones of the plurality of grommets.

4. A releasable fastener assembly comprising:
a flexible strap having a thickness, the flexible strap defining a plurality of apertures, each of the apertures extending through the thickness of the strap;
a plurality of grommets, each of the plurality of grommets being positioned in one of the plurality of apertures of the flexible strap and engaged with the flexible strap, each of the plurality of grommets comprising
a first annular end flange,
a generally cylindrical portion, the generally cylindrical portion of each of the plurality of grommets has a first inner diameter,
a second annular end flange opposite the first annular end flange, the second annular end flange has a second inner diameter,
the first inner diameter is greater than the second inner diameter,
the first and second inner diameters cooperate to define a passage extending through the grommet,
the second annular end flange comprising a substantially flat annular surface within the passage; and
a pin comprising
a shaft, the shaft comprising a proximal end and a distal end,
a head integral with the distal end of the shaft, and
a retractable latching mechanism positioned proximate to the proximal end of the shaft;
wherein the flexible strap is configured to define a loop such that the passage of a first one of the plurality of grommets is aligned with the passage of a second one of the plurality of grommets,
the pin is selectively insertable through the passage of the first one of the plurality of grommets and through the passage of the second one of the plurality of grommets, and
the head of the pin abuts the second annular flange of the first one of the plurality of grommets and the retractable latching mechanism abuts the substantially flat annular surface within the passage of the second one of the plurality of grommets when the pin is inserted through the passage of each of the first and the second ones of the plurality of grommets.

5. The releasable fastener assembly of claim 4, wherein the proximal end of the shaft is located between the first and second annular end flanges of the second one of the plurality of grommets when the pin is inserted through the passage of each of the first and the second ones of the plurality of grommets.

6. A releasable fastener assembly comprising:
a first flexible strap having a first thickness, the first flexible strap defining a first aperture, the first aperture extending through the first thickness of the strap;
a second flexible strap having a second thickness, the second flexible strap defining a second aperture, the second aperture extending through the second thickness of the strap;
a first grommet positioned in the first aperture and engaged with the first flexible strap,
a second grommet positioned in the first aperture and engaged with the second flexible strap,
each of the first and second grommets comprising
a first annular end flange, the first annular end flange comprising
an outer surface, the outer surface comprising a substantially flat portion,
a second annular end flange opposite the first annular end flange, and
a generally cylindrical portion, the generally cylindrical portion extending between the first annular end flange and the second annular end flange and defining a passage extending through the grommet; and
a pin comprising
a shaft, the shaft comprising a proximal end and a distal end,
a head integral with the distal end of the shaft, and
a retractable latching mechanism positioned proximate to the proximal end of the shaft;
wherein the first flexible strap and the second flexible strap are positioned such that the passage of the first grommet is aligned with the passage of the second grommet,
the pin is selectively insertable through the passage of the first grommet and through the passage of the second grommet, and
the head of the pin abuts the second annular flange of the first grommet and the retractable latching mechanism abuts the substantially flat portion of the second grommet when the pin is inserted through the passage of each of the first and the second grommets.

7. A releasable fastener assembly comprising:
a first flexible strap having a first thickness, the first flexible strap defining a first aperture, the first aperture extending through the first thickness of the strap;
a second flexible strap having a second thickness, the second flexible strap defining a second aperture, the second aperture extending through the second thickness of the strap;
a first grommet positioned in the first aperture and engaged with the first flexible strap,
a second grommet positioned in the second aperture and engaged with the second flexible strap,
each of the first and second grommets comprising
a first annular end flange,
a second annular end flange opposite the first annular end flange,
a first generally cylindrical portion with a first inner diameter,
a second generally cylindrical portion with a second inner diameter, the second inner diameter greater than the first inner diameter,
the first and second inner diameters cooperating to define a passage extending through the grommet, and
the first generally cylindrical portion comprising a substantially flat annular surface within the passage; and
a pin comprising
a shaft, the shaft comprising a proximal end and a distal end,
a head integral with the distal end of the shaft, and
a retractable latching mechanism positioned proximate to the proximal end of the shaft;
wherein the first flexible strap and the second flexible strap are configured such that the passage of the first grommet is aligned with the passage of the second grommet,
the pin is selectively insertable through the passage of the first grommet and through the passage of the second grommet, and
the head of the pin abuts the second annular flange of the first grommet and the retractable latching mechanism abuts the substantially flat annular surface when the pin is inserted through the passage of each of the first and the second grommets.

8. The releasable fastener assembly of claim 7, wherein the proximal end of the shaft is located between the first and second annular end flanges of the second grommet when the pin is inserted through the passage of each of the first and the second grommets.

9. A releasable fastener assembly comprising:
a flexible strap comprising
a first portion with a first thickness, the flexible strap defining a first aperture, the aperture extending through the first thickness of the first portion;
a second portion comprising a first layer and a second layer of flexible material,
the first layer having a first layer thickness,
the first layer defining a second aperture,
the second aperture extending through the first layer thickness;
a grommet positioned in the first aperture and engaged with the first portion of the flexible strap, the grommet comprising
a first annular end flange, the first annular end flange comprising
an outer surface, the outer surface comprising a substantially flat portion,
a second annular end flange opposite the first annular end flange, and
a generally cylindrical portion, the generally cylindrical portion extending between the first annular end flange and the second annular end flange and defining a passage extending through the grommet; and,
a pin comprising
a shaft, the shaft comprising a proximal end and a distal end and sized to be press fit with the second aperture,
a head integral with the distal end of the shaft and sized to be larger than the second aperture, and
a retractable latching mechanism positioned proximate to the proximal end of the shaft;
wherein the proximal end of the pin extends through the second aperture, the first and second layers are affixed to each other and the pin head is captured between the first and second layers,
the first and second portions of the flexible strap are configured to define a loop such that the passage of the grommet is aligned with the pin,
the pin is selectively insertable through the passage of the first grommet, and
the retractable latching mechanism abuts the substantially flat portion when the pin is inserted through the passage of the first grommet.

10. The releasable fastener assembly of claim 9 wherein the first and second layers are affixed by sewing.

11. The releasable fastener assembly of claim 9 wherein the first and second layers are affixed by gluing.

12. A releasable fastener assembly comprising:
a first flexible strap having a first thickness, the first flexible strap defining a first aperture, the first aperture extending through the first thickness;
a second flexible strap comprises a first layer and a second layer of flexible material,
the first layer having a first layer thickness,
the first layer defining a second aperture,
the second aperture extending through the first layer thickness;
a grommet positioned in the first aperture and engaged with the first flexible strap, the grommet comprising
a first annular end flange, the first annular end flange comprising
an outer surface, the outer surface comprising a substantially flat portion,
a second annular end flange opposite the first annular end flange, and
a generally cylindrical portion, the generally cylindrical portion extending between the first annular end flange and the second annular end flange and defining a passage extending through the grommet; and
a pin comprising
a shaft, the shaft comprising a proximal end and a distal end and sized to be press fit with the second aperture,
a head integral with the distal end of the shaft and sized to be larger than the second aperture, and
a retractable latching mechanism positioned proximate to the proximal end of the shaft;
wherein the proximal end of the pin extends through the second aperture, the first and second layers are affixed to each other and the pin head is captured between the first and second layers,
the first flexible strap and the second flexible strap are positioned such that the passage of the grommet is aligned with the pin,
the pin is selectively insertable through the passage of the grommet, and
the retractable latching mechanism abuts the substantially flat portion when the pin is inserted through the passage of the grommet.

13. The releasable fastener assembly of claim 12 wherein the first and second layers are affixed by sewing.

14. The releasable fastener assembly of claim 12 wherein the first and second layers are affixed by gluing.

15. A method for attaching a grommet to a flexible strap, the method comprising the steps of:
creating a plurality of apertures in the flexible strap;
positioning each one of a plurality of grommets into the respective one of the plurality of apertures,
each of the plurality of grommets comprising
a first annular end flange, the first annular end flange comprising
an outer surface, the outer surface comprising a substantially flat portion,
a second annular end flange opposite the first annular end flange, and
a generally cylindrical portion, the generally cylindrical portion extending between the first annular end flange and the second annular end flange and defining a passage extending through the grommet; and
engaging each of the plurality of grommets with the strap;
wherein the engaging each of the plurality of grommets with the strap creates the substantially flat portion.
